(19) United States
(12) Patent Application Publication
(10) Pub. No.: US 2008/0222681 A1
(43) Pub. Date: Sep. 11, 2008

(54) Method for Recording Multiple Program in Digital Broadcasting Receiver

(75) Inventor: Do-Hong Kwon, Kyunggi-do (KR)

Correspondence Address: GREENBLUM & BERNSTEIN, P.L.C., 1950 ROLAND CLARKE PLACE, RESTON, VA, 20191, US

(73) Assignee: KAONMEDIA CO., LTD., Kyunggi-do (KR)

(21) Appl. No.: 11/719,272

(22) PCT Filed: Apr. 8, 2005
(86) PCT No.: PCT/KR2005/001029

§ 371 Date: Aug. 1, 2007

(30) Foreign Application Priority Data
Oct. 11, 2004 (KR) 10-2004-0080949
Jan. 18, 2005 (KR) 10-2005-0004533

(51) Int. Cl. G06F 13/00

(52) U.S. Cl. 725/46

(57) ABSTRACT

The invention relates to a method for recording multiple programs in a digital broadcasting receiver. The digital broadcasting receive, when receiving a record command for multiple programs in the broadcast signal currently incoming, confirms and stores PID's of each of the programs corresponding to the record command. Thereafter, the digital broadcasting receiver searches the broadcast data for the PID's so as to store broadcast data by matching PID values. According to the present invention, the method for recording multiple programs is advantageous in that a broadcasting receiver may be implemented so as to simultaneously record multiple programs.

### TECHNICAL FIELD

The present invention relates to a method for recording multiple programs in a digital broadcasting receiver, wherein the digital broadcasting receiver can separate incoming multiple channel services multiplexed into one transport stream and then simultaneously record or play programs of the separated multiple channel services.

### BACKGROUND ART

Generally, with the recent development of digital TV technologies, schemes for transmitting broadcast signals have also been developed and thus attention is gradually drawn to digital TVs to which a digital transmission scheme is applied.

Researches on digital TVs for receiving digital broadcast, set-top boxes for digital TVs, and the like are actively conducted in accordance with a future digital broadcast plan to provide users with better services by transmitting higher image quality over conventional analog broadcast and sound quality close to the level of CDs.

Such a digital TV has a function by which a user can record video in real time while watching broadcast and play the video at the time when he/she wants to play it, using a personal video recorder (PVR). Further, in addition to recording of a favorite broadcast program, such a function can also be used to record a videoconference when the digital TV is used for the videoconference.

Here, the PVR system is a system for recording or playing broadcast by storing input broadcast signals (digital broadcast, analog broadcast, video, etc.) using an internal storage device (hard disk).

Recently, with a tendency of terrestrial receivers to more popularization and higher grade, they have been more complicated and a variety of products have been placed on the market. Among them, a personal video recorder (PVR) has recently been highlighted.

PVR is a personal digital video recorder for recording and playing information in and from a hard disk. It is a new conceptual digital recorder for recording and playing information in and from a hard disk, contrary to a VCR for storing video signals in a magnetic tape. Further, the PVR is a next-generation recorder for recording broadcast programs using a hard disk drive built in the body of a set-top box or TV, depending on the capacity of the hard disk even without a VCR.

When a channel is selected in a PVR, current broadcast signals are automatically stored in digital mode in a hard disk drive and simultaneously played. Thus, if a stop button is pushed and a play button is pushed again, the stored broadcast signals are played again from the point of time when they were stopped. Further, it is possible to watch a current broadcast program again, to play the program in slow motion, or to skip a boring part thereof. Thus, the PVR has a convenient function by which a desired part of a program can be searched and edited.

Until now, a digital broadcasting receiver has been adapted to receive only real-time broadcast with a single tuner, but gradually shows a tendency to have a built-in hard disk and perform an additional function of recording a currently watched program in place of an existing VCR.

Recently, there has been proposed a digital broadcasting receiver having two built-in tuners of which one is used to watch real time broadcast and the other is used to record a program on another channel so that the program can be played and watched later.

A current dual tuner type digital broadcasting receiver can record only a currently watched program on a channel and a program on another channel, which is not being currently watched.

However, conventional digital broadcasting receivers do not allow users to simultaneously watch and record programs of several tens to hundreds of services in a digital multi-channel environment.

Further, they have a disadvantage in that broadcast data on a great number of scrambled channels cannot be recorded in spite of payment of much money.

### DETAILED DESCRIPTION OF THE INVENTION

### DISCLOSURE OF THE INVENTION

Accordingly, an object of the present invention is to provide a method for recording multiple programs in a digital broadcasting receiver, wherein the digital broadcasting receiver can effectively separate and store multiple channel services multiplexed into one transport stream and simultaneously record or play programs on multiple channels.

### BRIEF DESCRIPTION OF THE DRAWINGS

FIG. 1a is a block diagram schematically showing a configuration of a digital broadcasting receiver for recording multiple programs using one tuner according to the present invention.

FIG. 1b is a block diagram schematically showing a configuration of a digital broadcasting receiver for recording multiple programs using two tuners according to the present invention.

FIG. 2 is a view showing a structure of a broadcast signal received through a tuner according to the present invention.

FIG. 3 is a flowchart illustrating a method of recording multiple programs in a digital broadcasting receiver according to the present invention.

FIG. 4a to 4c are exemplary views of screens when multiple programs are recorded in a digital broadcasting receiver according to the present invention.

FIG. 5 is a view showing a structure of a database in which multiple programs are stored according to the present invention.

### BEST MODE FOR CARRYING OUT THE INVENTION

Hereinafter, a preferred embodiment of the present invention will be described in detail with reference to the accompanying drawings.

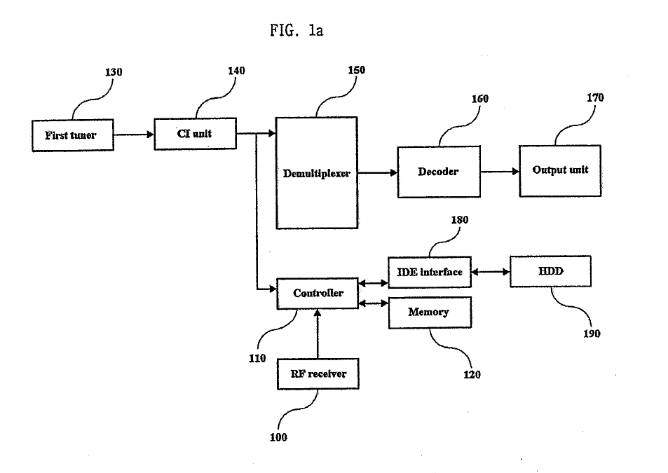

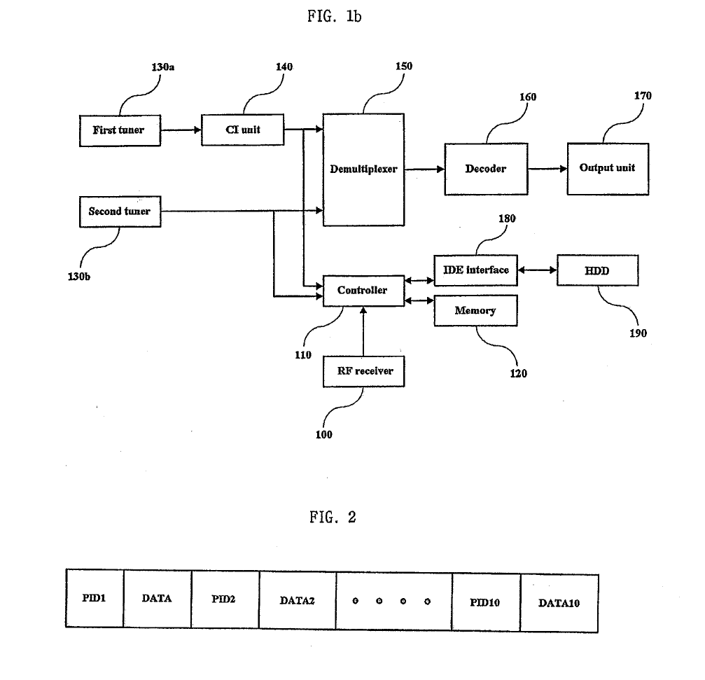

FIG. 1a is a block diagram schematically showing a configuration of a digital broadcasting receiver for recording multiple programs using one tuner according to the present invention, FIG. 1b is a block diagram schematically showing a configuration of a digital broadcasting receiver for recording multiple programs using two tuners according to the present invention, and FIG. 2 is a view showing a structure of a broadcast signal received through a tuner according to the present invention.

Referring to FIG. 1a, the digital broadcasting receiver for recording multiple programs using one tuner comprises an RF receiver 100, a controller 110, a memory 120, a tuner 130, common interface (CI) unit 140, a demultiplexer 150, a decoder 160, an output unit 170, an DE interface unit 180 and a HDD 190.

The RF receiver 100 receives information on a remote control code, which has been selected by a user, and then transmits it to the controller 110.

The controller 110 decodes the remote control code transmitted from the RF receiver 110 and then transmits decoding information on the remote control code to a corresponding device.

For example, when the decoding information on the remote control code is a channel-changing request command, the controller 110 transmits the channel-changing request command to the tuner 130. When the decoding information on the remote control code is a broadcast program record command, the controller performs control to record the corresponding program.

That is, when the record command is input from the user, the controller 110 identifies a PID of a program on a channel where the record command has been input, and then stores it in an internal memory.

Thereafter, the controller 110 searches for a PID (Program ID) corresponding to the input record command in broadcast signals received through the tuner 130 and then performs control to record the program. PIDs (Program IDs) are set in advance by programs.

The memory 120 includes a flash ROM for storing software such as an operating system, and a DRAM for storing virtual pictures in the form of bitmaps to be expressed in the output unit.

The tuner 130 receives a broadcast signal on a channel selected by the control of the controller 110. Here, multiple channels (programs) are contained in the received broadcast signal, i.e., one transport stream. Thus, the user can watch two programs in the broadcast signal received through one tuner, using a PIP function, and can record multiple channels (programs).

In other words, the broadcast signal received through the tuner 130 has a structure in which PIDs and broadcast data are combined as shown in FIG. 2. The broadcast data include combinations of audio data, video data and the like.

If the broadcast signal received through the tuner 130 has been scrambled, the CI unit 140 determines whether the corresponding user is a registered user, and then descrambles the scrambled broadcast signal. In other words, the CI unit 140 determines whether the corresponding user is a registered user when the scrambled broadcast signal is received. If it is determined that the user is a registered user, the CI unit 140 descrambles the scrambled broadcast signal and then transmits the descrambled broadcast signal to the demultiplexer 150 or the controller 110.

The demultiplexer 150 parses a variety of information such as audio, video and other data multiplexed in the broadcast signal supplied from the tuner 130 or the CI unit 140.

Further, the demultiplexer 150 classifies data in the broadcast signal supplied from the tuner 130 or the CI unit 140 according to PIDs, so that a program with a PID corresponding to the record command input by the user is stored in the HDD 190 through the controller 110.

The decoder 160 decodes audio data, video data and other data obtained through parsing by the demultiplexer 150, and processes the data so that the user can watch and listen to them. For recording of the broadcast data, the IDE interface unit 180 receives the broadcast data transmitted from the CI unit 140 or the tuner 130 and then transmits the data to the HDD 190. When a play request command is received, the IDE interface unit transmits the data stored in HDD 190 to the decoder 160 or the CI unit 140.

That is, in a case where the play request command is input, if the corresponding broadcast data are scrambled data, the IDE interface unit 180 transmits the data to the CI unit 140 so that the data can be descrambled and then played. If the broadcast data are descrambled data, the IDE interface unit transmits the data to the decoder 160.

The HDD 190 stores the broadcast data transmitted from the IDE interface unit 180. In other words, the HDD 190 stores a program selected according to a record command from the user. Multiple programs can be stored in the HDD 190. As for the data stored in HDD 190, respective channel numbers, PIDs, and broadcast data (transport stream) are stored together to be conveniently managed upon playing of the data.

In the digital broadcasting receiver constructed as above, since the broadcast signal passing through the single tuner 130 is large-size data having multiple channels, the broadcast signal can be separated into different channel data up to six channels if a record command is input to the data.

To perform recording on a channel basis, PIDs used in the respective channels are identified, and the respective PIDs are stored in a recording list. Thereafter, the identified PIDs are searched in a broadcast signal received through the tuner 130, and broadcast data (programs) corresponding thereto are stored. When the broadcast data (programs) are stored, channel numbers, PIDs, and broadcast data (transport stream) are stored together to be conveniently managed upon playing of the data.

FIG. 1b shows a digital broadcasting receiver for recording multiple programs using two tuners, and the tuner 130 comprises a first tuner 130a and a second tuner 130b.

The first tuner 130a receives a broadcast signal corresponding to a main picture and the second tuner 130b receives a broadcast signal corresponding to a sub-picture.

Since the dual tuner digital broadcasting receiver has the same configuration of the digital broadcasting receiver shown in FIG. 1a except that the dual tuner digital broadcasting receiver has two tuners, a detailed description thereof will be omitted.

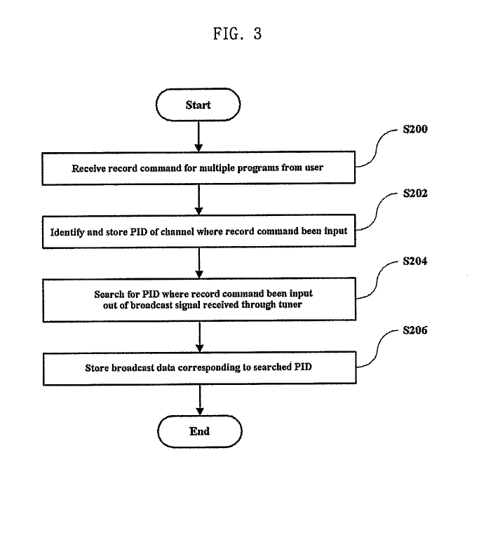

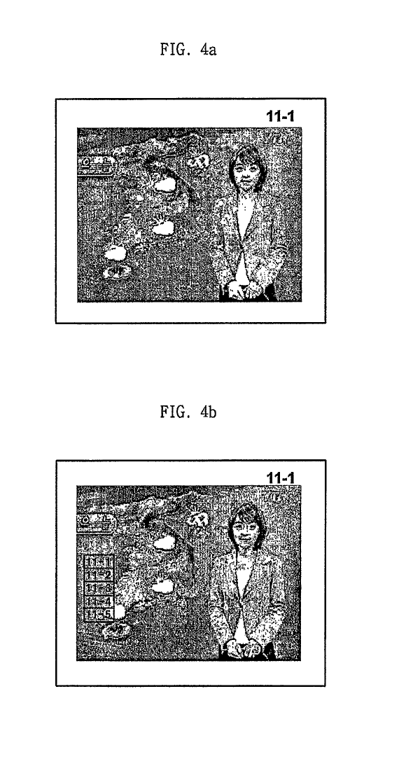

FIG. 3 is a flowchart illustrating a method of recording multiple programs in a digital broadcasting receiver according to the present invention, and FIG. 4a to 4c are exemplary views of screens when multiple programs are recorded in a digital broadcasting receiver according to the present invention.

Referring to FIG. 3, if a record command for multiple programs is input by a user (S200), the digital broadcasting receiver identifies and stores PIDs of channels where the record command has been input (S202).

In other words, the user causes a program, which is required to be recorded by the user, to be displayed as a main or whole picture while switching a channel, and then inputs a record command. Then, the digital broadcasting receiver identifies and stores PIDs of channels where the record command is input.

A method by which a user records multiple programs in a digital broadcasting receiver will be described with reference to FIG. 4a to 4c.

If the user wants to record a program on channel 11-1 while watching the channel, he/she selects a record button. Then, the digital broadcasting receiver searches for a PID of channel 11-1 at the point of time when the record command has been input, and stores the record command in a form of a list. Thereafter, the digital broadcasting receiver searches for broadcast data (audio and video data) corresponding to the stored PID (channel 11-1) in a broadcast signal received through a tuner and then stores the searched data in a HDD. At this time, the digital broadcasting receiver stores a PID, a channel number, broadcast data and the like.

When the user selects a channel button in order to view a channel list included in the current broadcast signal received through the tuner while the broadcast data on channel 11-1 are being stored, the digital broadcasting receiver displays the channel list included in the broadcast signal currently being broadcast as shown in FIG. 4b. The channel list is displayed in the form of a popup window on a main picture.

For example, if a user selects a channel button in a digital broadcasting receiver with a single tuner, the digital broadcasting receiver displays only a channel list included in a broadcast signal received through the tuner. If a user selects a channel button in a digital broadcasting receiver with two tuners, the digital broadcasting receiver displays both a channel list included in a broadcast signal received through a first tuner and a channel list included in a broadcast signal received through a second tuner.

If the user wants to watch another channel (e.g., channel 11-4) after viewing the channel list displayed as shown in FIG. 4b, the user selects desired channel 11-4 from the channel information displayed in the popup window. Then, the digital broadcasting receiver displays a broadcast picture on selected channel 11-4, as shown in FIG. 4c. At this time, if the user selects a PIP command, the broadcast picture on selected channel 11-4 is displayed as a PIP picture.

If the user wants to record the program on channel 11-4 broadcasted as shown in FIG. 4c, he/she selects the record button. Then, the digital broadcasting receiver searches for a PID of channel 11-4 at the time when the record command has been input, and then stores the record command in a form of a list. Thereafter, the digital broadcasting receiver searches for broadcast data corresponding to the stored PID (channel 11-4) in the broadcast signal received through the tuner, and then stores the data in the HDD.

Here, in a case where the program on channel 11-4 is displayed as a PIP picture, if the user wants to record the broadcast data on channel 11-4, the user causes the program on channel 11-4 to be displayed as a whole picture and then selects the record button. Then, the digital broadcasting receiver stores the broadcast data on the channel in the HDD.

In other words, the digital broadcasting receiver searches for channels 11-1 and 11-4 where the record command has been input, in the broadcast signal received through the tuner, and then stores the broadcast data on the channels in the HDD at a time. Although the digital broadcasting receiver has been described as simultaneously recording broadcast data corresponding to two channels, the digital broadcasting receiver can simultaneously record broadcast data corresponding to more than two channels by means of the aforementioned method.

After performing step 202, the digital broadcasting receiver searches for PIDs where the record command has been input, in the broadcast signals received through the respective tuners (S204). That is, since there exist multiple channel services in the broadcast signals received through the respective tuners, the digital broadcasting receiver searches for the PIDs where the record command has been input by the user, in the received broadcast signals. Since the broadcast signals received through the tuners are in the form of a combination of PIDs and broadcast data, the digital broadcasting receiver can search for the corresponding PIDs in the received broadcast signals.

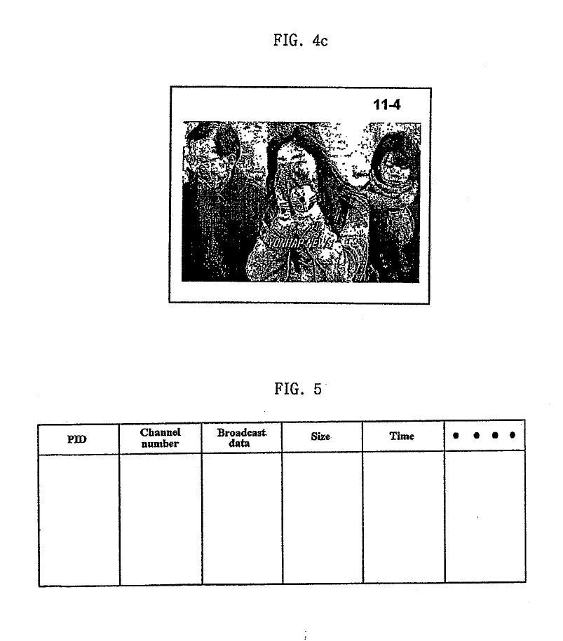

After performing step 204, the digital broadcasting receiver stores broadcast data corresponding to the searched PIDs (S206). In other words, the digital broadcasting receiver first identifies PIDs used in the respective channels, sets recording for the respective PIDs, separates the demultiplexed transport streams again on a PID basis, and then stores them as shown in FIG. 5.

For example, if the user inputs a record command at channels corresponding to MBC1, MBC2, MBC3 and MBC4, the digital broadcasting receiver extracts PIDs of the channels where the record command has been input, in broadcast signals received through the tuners, and stores data corresponding to the PIDs in the HDD.

Then, programs on the respective channels of MBC1, MBC2, MBC3 and MBC4 are stored in the HDD.

The programs stored in the HDD are stored as shown in FIG. 5.

FIG. 5 is a view showing a structure of a database in which multiple programs are stored according to the present invention.

Referring to FIG. 5, the data stored in the HDD include information such as PID, channel number, broadcast data, size and time.

In a case where the broadcast signals received through the tuners are scrambled signals, if there exists a CI unit, the signals are stored in a descrambled state. If there exists no CI unit, the signals are stored in a scrambled state.

When data stored in the scrambled state are played, the CI unit decodes and outputs the data in the descrambled state.

It will be apparent that the present invention is not limited to the embodiment and those skilled in the art can make various modifications within the spirit and scope of the present invention.

### INDUSTRIAL APPLICABILITY

As described above, according to the present invention, there is provided a method for recording multiple programs in a digital broadcasting receiver, wherein multiple programs can be recorded contrary to a one-tuner type or two-tuner type digital broadcasting receiver capable of recording only one or two programs, respectively.

Further, according to the present invention, there is provided a method for recording multiple programs in a digital broadcasting receiver, wherein a single receiver can perform recording that was performed by a plurality of digital broadcasting receivers, and can also improve user's convenience by effectively storing programs through schedule management.

Further, according to the present invention, there is provided a method for recording multiple programs in a digital broadcasting receiver, wherein with the efficient management of scrambled data, a program recorded in a state where there exists a CI unit can be played without a CI unit, while a program recorded in a state where there exists no CI unit can be formed into scrambled data and then played, thereby accepting all the charged channel environment.

1-4. (canceled)

5. A method for simultaneously recording multiple programs in a digital broadcasting receiver with a tuner for receiving broadcast signal, wherein said broadcast signal includes information on at least one channel, wherein said channel information includes broadcast data containing information on channel numbers, PIDs, audio data and video data, wherein the method comprising steps of:
(a) receiving a record command from a user for a current broadcast program;
(b) identifying PIDs of the program where said record command is provided with storing said identified PIDs;
(c) displaying, when a channel button has been selected so as to allow viewing a channel list contained in the broadcast signal being currently broadcast, said channel list contained in said broadcast signal;
(d) switching into channels which is selected by the user out of said channel list with performing said steps (a) and (b) for programs on each selected channels responding to a request by the user;
(e) identifying multiple of programs where the record command is provided by the user out of the broadcast signal received through said tuner; and
(f) storing program data including all or a part of PIDs, channel number, broadcast data, size, and record time corresponding to each of said identified programs, wherein said program data is stored being sorted by program.

6. The method as claimed in claim 5, wherein said step (f) comprises steps of:
(f-1) identifying whether said broadcast data is scrambled or not;
(f-2) determining said user is a valid subscriber;
(f-3) descrambling, if said user is a valid subscriber, said broadcast data; and
(f-4) storing said descrambled broadcast data in a storage device.

7. The method as claimed in claim 6, wherein said step (c) comprises a step of displaying said channel list as channel numbers in a form of a popup window.
